(19) United States
(12) Patent Application Publication
(10) Pub. No.: US 2014/0127539 A1
(43) Pub. Date: May 8, 2014

(54) Vehicle Having a Battery

(71) Applicant: Jan Helber, Balingen (DE)

(72) Inventor: Jan Helber, Balingen (DE)

(73) Assignee: Daimler AG, Stuttgart (DE)

(21) Appl. No.: 14/115,579

(22) PCT Filed: Dec. 9, 2011
(86) PCT No.: PCT/EP2011/006215

§ 371 Date: Dec. 19, 2013

(30) Foreign Application Priority Data
May 5, 2011 (DE) 10 2011 100 623.4

(51) Int. Cl. H01M 2/10; H01M 10/613

(52) U.S. Cl. CPC H01M 2/1083; H01M 10/5004
USPC 429/56; 429/98; 429/53

(57) ABSTRACT

A vehicle includes a battery and a vehicle support structure having multiple supports designed as hollow sections. The battery has at least one ventilation opening. The at least one ventilation opening in the battery is connected to the interior of at least one of the supports designed as hollow sections, and via same is connected, directly or via further supports designed as hollow sections, to the surroundings of the vehicle.

### BACKGROUND AND SUMMARY OF THE INVENTION

Exemplary embodiments of the present invention relate to a vehicle having a battery and a vehicle support structure.

Vehicles that are at least partially electrically driven are known. These vehicles require batteries, also referred to as traction batteries, which store electrical power for propulsion of the vehicle. These batteries must be housed in the vehicle in a safe and stable manner with as little space consumption as possible, for example so that there is little or no reduction of the cargo space in the vehicle.

German Unexamined Patent Application DE 10 2007 063 193 A1 discloses a battery having overpressure protection. Batteries used as traction batteries in vehicles are typically implemented in storage technologies having a high storage density, for example lithium-ion technology. In these types of technologies there is the risk a short circuit or overcharging of the battery may result in overpressure in the overall battery or in single individual battery cells from which the overall battery is typically built. To be able to reduce such overpressure in an emergency before the battery and the surroundings of the battery are damaged, closure elements are typically provided to open in the event of damage are situated in the area of the individual battery cells and/or in the area of a battery housing of the overall battery enclosing same. The above-mentioned German Unexamined Patent Application describes, for example, such overpressure protection in the area of a housing of an individual battery cell. This overpressure protection is composed of a bursting element designed, for example, as a diaphragm or as part of the housing having a predetermined breaking point. If overpressure occurs inside the individual battery cell, for example due to a short circuit, the overpressure protection opens and releases the overpressure. A comparatively large quantity of gases may be generated so that a battery housing enclosing the individual battery cells according to the general prior art typically has ventilation openings that are either open or closed, likewise via a bursting element or the like. When this type of battery is used in a vehicle, it is important that the comparatively large quantity of gas that may result during overcharging of the battery is reliably discharged from the vehicle without entering the interior of the vehicle, in which the occupants typically sit, who could possibly be harmed by the gases.

Therefore, in the generally common designs the ventilation openings in the battery are typically situated in the area of a battery housing enclosing the overall battery, and are connected to the surroundings of the vehicle via corresponding line elements. These line elements must be tightly connected to the ventilation opening, and thus installed in the vehicle in such a way that penetration of the gases, which flow out in the event of overpressure, into the interior of the vehicle is safely and reliably avoided. The level of effort with regard to the line elements, routing of the lines, and the design and sealing of interfaces is therefore comparatively high.

In addition, it is known from the further general prior art to provide batteries in the area of a support structure of a vehicle.

U.S. Patent Application Publication U.S. 2010/0213741 A1, for example, describes the provision of electrochemical components, in this case fuel cells, in a central tunnel of the vehicle, i.e., in the area of the support structure of the vehicle. In order to not unnecessarily stress the electrochemical units in the event of a collision, the central tunnel has appropriate bracing situated between the electrochemical units and which ensures that forces in the event of a collision are not conducted via the electrochemical components. Safety is thus increased, and the risk of possible damage to the electrochemical units is reduced.

Furthermore, French patent document FR 2 942 764 A1 discloses providing energy storage devices, for example also batteries, in areas of the support structure of a vehicle in which free spaces remain. The corresponding devices for energy storage may thus be integrated into the support structure of the vehicle in a space-saving manner, and do not take away from installation space otherwise needed.

Both of these documents thus describe the integration of fuel cells or batteries into existing cavities in the support structure of a vehicle.

Exemplary embodiments of the present invention are directed to providing a vehicle having a battery, in which the required installation space may be minimized.

In accordance with exemplary embodiments of the present invention, a vehicle is provided having at least one ventilation opening in the battery connected to the interior of at least one of the supports designed as hollow sections, and via same is connected, directly or via further supports designed as hollow sections, to the surroundings of the vehicle. According to the invention, the supports, which typically are designed as hollow sections anyway, and which are often designed as tubes having a circular or rectangular cross section, are used as line elements for discharging the gases exiting from the ventilation opening in the battery in the event of damage. The hollow sections of the supports typically have a correspondingly large cross section so that the comparatively large quantities of gas forming in the area of the battery in the event of damage may be easily discharged through the supports. The supports, which are designed as hollow sections, are typically connected at their end faces to the exterior of the vehicle body, and have no connection to the interior of the vehicle. For this reason, the supports are ideally suited for discharging the gases to the surroundings without endangering the occupants of a vehicle. Additional line elements, which are necessary in the prior art, may be dispensed with here. It is necessary only to provide an opening at an appropriate location in the area of the support, or optionally at the transition from one of the supports to another support. Compared to the designs from the prior art, the design is therefore ideal in terms of installation space, necessary components, and in particular the installation and sealing effort.

In one advantageous embodiment of the vehicle according to the invention, the battery is situated in the area of the support structure. Such an arrangement of the battery in the area of the support structure is ideal for the vehicle having the design according to the invention, since any line elements between the ventilation opening and the entrance into the hollow sections of the support structure are thus minimized or may be dispensed with.

In another very advantageous embodiment of the vehicle according to the invention, the battery includes a battery housing having at least one ventilation opening, the at least one ventilation opening cooperating directly with at least one opening in at least one of the supports.

Thus, in this particularly preferred design of the vehicle according to the invention, all line elements may be dispensed with due to the fact that the ventilation opening in a battery housing of the battery cooperates directly with the support. In this case a fixed connection, for example an integral or form-fit connection, may be present, or a sealing connection may be provided via a sealing element. The design then requires only a single sealing element between the battery housing and the support, or an integral connection may be dispensed with altogether.

In one particularly favorable, advantageous refinement of the vehicle according to the invention, the battery has a battery housing, the battery housing or a portion of the battery housing, in particular a floor pan of the battery housing, is designed as a component of the support structure.

In this particularly preferred refinement, the battery housing or a portion of the battery housing may thus take over a function as a battery housing as well as a supporting function as a component in the support structure of the vehicle. Due to this double functionality of the battery housing as a battery housing on the one hand and as a component of the support structure of the vehicle on the other hand, additional installation space may be saved, since portions of the conventional support structure, which are replaced by the battery housing or a portion of the battery housing, may be dispensed with.

The use of the battery housing or a portion of the battery housing as a component of the support structure allows a stable, rigid support structure, and also allows the electrochemical design of the battery, which typically is designed in the form of one or more stacks of prismatic individual battery cells, to be implemented as comparatively weak in a conventional manner. The complexity of manufacturing the battery and the installation weight of the battery may thus be spared, while at the same time at least a portion of the battery housing, which is necessary anyway, may be designed as a highly stable component of the support structure.

In one very advantageous refinement thereof, the battery housing has at least one bracing element, in particular in the form of cooling devices for the battery.

Such a bracing element in the battery housing may be used to provide the battery housing, as a component of the support structure, with sufficient stability and rigidity without having to design the overall battery housing to be unnecessarily heavy.

The typical design of batteries as used, for example, as traction batteries in vehicles that are at least partially electrically driven provides that individual battery cells are used which require active cooling. These individual battery cells, for example in lithium-ion technology, are frequently stacked as prismatic individual battery cells into one or more cell stacks and combined to form the battery. To ensure reliable, uniform cooling of the individual battery cells, at least one cooling device, which is often designed as a plate or in the form of tubes and situated on one or more of the sides of the cell stack, is typically present for heat regulation and cooling of the individual battery cells. This cooling device, which is designed in particular as a metallic plate and through which a cooling medium, for example a coolant of an air conditioner, actively flows, is typically very rigid, and may ideally take over the functionality of a bracing element in the battery housing in addition to the functionality of the cooling. The design may thus provide a very rigid battery housing that is ideally suited as a component of the support structure of the vehicle, and which due to the design of the bracing elements as a cooling device may also save installation space and weight of a separate cooling device or separate bracing elements.

In one very advantageous refinement of the vehicle according to the invention, the battery is provided as a traction battery for storing electrical drive power in the at least partially electrically driven vehicle. The battery is particularly suited as a traction battery, for example for an electric vehicle or in particular for a hybrid vehicle, since it may be integrated into the design heretofore of the support structure of the vehicle, essentially without requiring additional installation space, and therefore may also be integrated into existing drive designs having an internal combustion engine in a very space-saving manner. Hybridization of the vehicle is thus possible in a simple and efficient manner.

### BRIEF DESCRIPTION OF THE DRAWING FIGURES

Further advantageous embodiments of the vehicle according to the invention are made clear by means of the exemplary embodiment which is described in greater detail with reference to the figures, which show the following:

FIG. 1 shows a schematic view of a support structure of a vehicle;

FIG. 2 shows a sectional illustration of an installed battery;

FIG. 3 shows one possible embodiment of an end-face end of a support of the support structure in a first state (a) and a second state (b);

FIG. 4 shows a schematic view of a support structure of a vehicle similar to that in FIG. 1, with an integrated battery; and

FIG. 5 shows the integration of a battery into the support structure of the vehicle in an enlarged illustrated section from FIG. 4.

### DETAILED DESCRIPTION

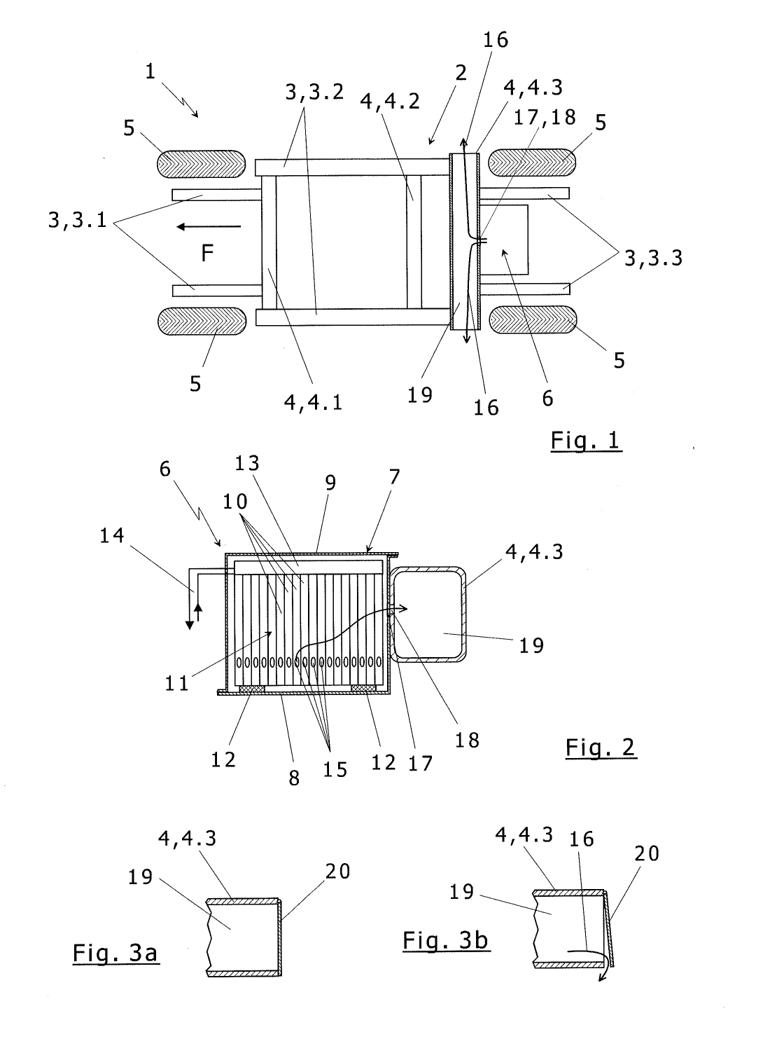

A vehicle 1 and the support structure 2 of such a vehicle 1 are indicated in greatly simplified and schematic form in the illustration in FIG. 1. The support structure is essentially composed of side beams 3 and cross beams 4. Wheels 5 of the vehicle 1 are also apparent in the illustration in FIG. 1. The direction of travel of the partially illustrated vehicle 1 is denoted by reference character F, so that the vehicle 1 is traveling forward in the direction of the arrow F. For better orientation, the side beams 3 and the cross beams 4 are numbered consecutively in the direction of travel, starting from the front of the vehicle 1. Accordingly, the side beams 3.1 are situated in the so-called front end of the vehicle 1, the side beams 3.2 are situated in the middle of the vehicle 1, and the side beams 3.3 are situated in the corner area of the vehicle. The cross beams 4 are similarly numbered, so that the cross beam 4 following on the front end is denoted by reference numeral 4.1, the middle cross beam is denoted by reference numeral 4.2, and the cross beam situated farthest to the rear in the direction of travel is denoted by reference numeral 4.3. The cross beam 4.3 is illustrated in cross section in FIG. 1. The design of the support structure 2 is understood to be purely schematic, and of course more or also fewer of the side beams 3 and of the cross beams 4 may be installed in this type of support structure.

In the exemplary embodiment of a vehicle 1 illustrated in FIG. 1, a battery 6 is situated in the area of the rear end of the vehicle. The battery 6, which is shown again in greater detail in the sectional illustration in FIG. 2, has a battery housing 7, which in the exemplary embodiment illustrated here is composed of a base part 8 and a cover part 9. Multiple individual battery cells 10 are situated in the battery housing 7 in a manner known per se. In the exemplary embodiment illustrated here, the individual battery cells 10 are each designed as prismatic individual battery cells 10, and are stacked to form a cell stack 11. Of course, alternative embodiments having cylindrical individual battery cells, for example, would likewise be conceivable. The collection of the individual battery cells 10—the cell stack 9 in the exemplary embodiment illustrated here—is accommodated in the battery housing 7 via schematically indicated holding elements 12, and may have suitable electronic components such as a battery management system, not illustrated here. In addition, active cooling of the individual battery cells 10 should be possible. In the exemplary embodiment illustrated here, this is indicated by a cooling device 13, which in the form of a cooling plate is situated on one side of the cell stack 11. The cooling device 13 may be actively cooled in a manner known per se, for example by a cooling circuit designed specifically for the battery 6 and/or by an air conditioner of the vehicle 1. This design of the cooling also does not play an important role for the invention and is known from the general prior art, and therefore is not discussed in greater detail. The active cooling is indicated merely by two cooling lines 14 for supplying and discharging a cooling medium.

Each of the individual battery cells 10 now has a closure element 15 which is designed as overpressure protection and implementable as a bursting element, for example. It would likewise be conceivable to design the closure element 15 in the form of a spring-loaded (check) valve or the like. If overpressure develops in one or more of the individual battery cells 10, for example due to a short circuit or unplanned overcharging, the closure element 15 will open at a specific pressure so that the gases may escape from the individual battery cell 10 in question. This is illustrated here using one of the individual battery cells 10 as an example. The gases, which are indicated by the arrows denoted by reference numeral 16, escape from the individual battery cell 10 and result in a corresponding overpressure in the battery housing 7. The battery housing 7 has a ventilation opening 17, which may either have an open design or which may be closed, likewise via a closure element, not illustrated here, in the manner of the closure element 15 of the individual battery cells 10. If overpressure now develops in the battery housing 7, the gas 16 escapes through the ventilation opening 17 and passes via a hole 18 into the area of the cross beam 4.3. The base part 8 of the battery housing 7 is thus connected to the cross beam 4 or pressed against same in such a way that a sealing connection results between the interior of the battery housing 7, with the ventilation opening 17 open, and the interior 19 of the cross beam 4.3. The gases 16 thus flow from the battery housing 7 into the interior 19 of the cross beam 4.3 designed as a hollow section, and may flow out from same typically at its open end faces, as is apparent in the illustration in FIG. 1.

Since the open end faces of the cross beam 4.3 are typically connected only to the surroundings of the vehicle 1 and not to the interior thereof, safe and reliable discharge, from the battery 6 to the surroundings, of any gases 16 that arise is ensured without occupants of the vehicle 1 coming into contact with the gases 16 and thus possibly being harmed.

In the illustration in FIG. 3, a possibility is apparent for appropriately closing the end faces of the cross beam 4 via a flap 20 as a check element. During routine operation, this ensures that, for example for a ventilation opening 17 that is permanently open, no contaminants penetrate into the battery housing 7 via the interior 19 of the cross beam 4.3. If gases 16 flow out, in this case the flap is opened against gravitational force of the flap, as is apparent in the illustration in FIG. 3b. In addition or as an alternative to gravitational force, a spring could likewise be provided here. Of course, it is also conceivable to use actively controlled flaps 20 or diaphragms as a bursting element.

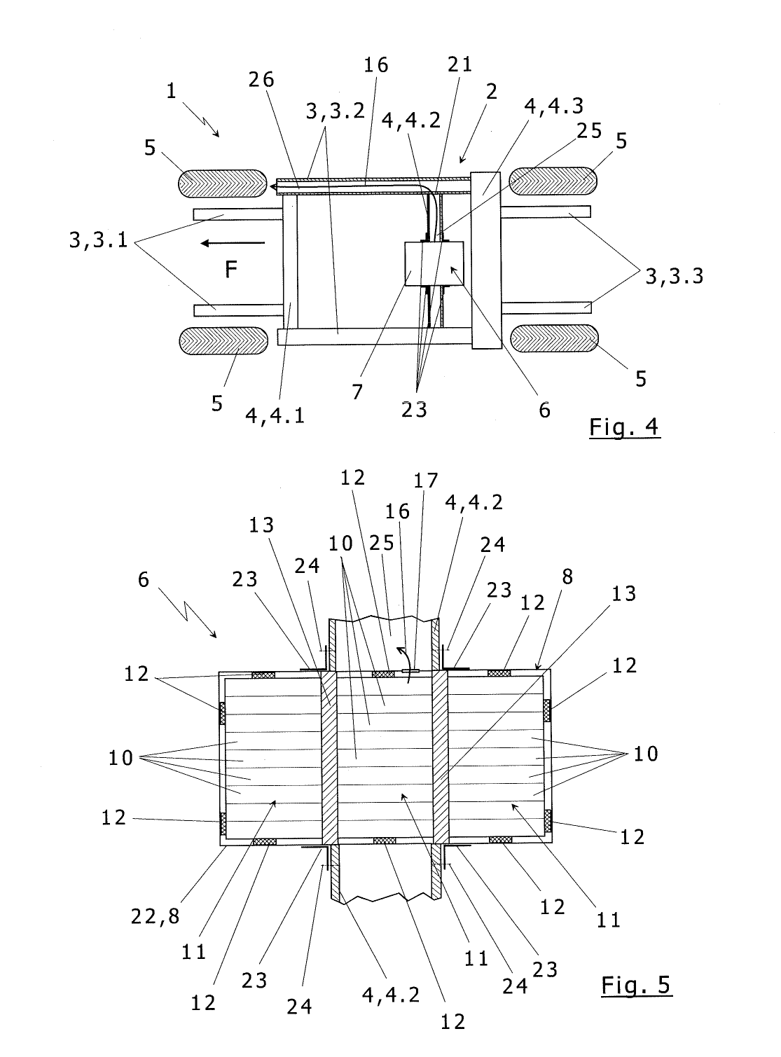

An alternative embodiment similar to the illustration in FIG. 1 is apparent in the illustration in FIG. 4.

The battery 6, in a manner to be described in greater detail below, forms a supporting component that is integrated into the support structure 2 and which in the exemplary embodiment illustrated here is designed as part of the cross beam 4.2. This cross beam together with a side beam 3.2 is apparent here in a sectional illustration. The battery 6 or the battery housing 7 once again has a ventilation opening 17, which is merely indicated in the illustration in FIG. 5. Any gases 16 present in the area of the battery 6 in the event of overpressure are then conducted through a portion of the cross beam 4.2, and via an opening 21 in one of the side beams 3.2 reach the interior of this side beam 3.2 and, corresponding to the arrows illustrated here, pass to the surroundings of the vehicle 1 via the end face of this side beam 3.2. In addition to the possibility of discharging any gases through the cross beam 4.2 and the side beam 3.2, the design illustrated in FIG. 4 has the major advantage that the battery 6 or a portion of the battery housing 7 is a component of the support structure 2. As is more clearly apparent in the illustration in FIG. 5, the battery housing 7 of the battery 6 is provided, for example, with a base part 8 designed as a floor pan 22 in such a way that the battery housing 7 has holders 23 that may be welded to the floor pan 22 of the battery 6, for example. These holders 23 are detachably connected to the two sections of the cross beam 4.2 via screws 24. The floor pan 22 may in particular be designed as a cavity in order to optimally transmit the forces from one portion of the cross beam 4.2 into the other portion of the cross beam with the lowest possible weight. The floor pan 22 may also have bracing elements which assist in this regard. Two of the cooling devices 13 in the form of cooling plates between the cell stacks 11 are apparent in cross section in the illustration in FIG. 5. Since the cooling devices are typically made of a metallic material and have correspondingly high rigidity, they may ideally form the bracing elements. The cooling devices may transmit forces from one side of the floor pan 22 to the other side thereof without the need for additional components.

The ventilation opening 17, which is designed, for example, as a permanent opening in the floor pan 22 of the battery 6, is apparent in the illustration in FIG. 5. The ventilation opening is connected to the interior 25 of one portion of the cross beam 4.2. For this purpose, the cross beam 4.2 may be mounted in the area of its end face or in the area of the holders 23 to the floor pan 22 of the battery 6, via a sealing element (not illustrated here) in such a way that the gases flow safely and reliably from the ventilation opening 17 into the interior 25 of the cross beam 4.2 without reaching the surroundings. As previously described for the illustration in FIG. 4, the gases then pass via the side beam 3.2 into the surroundings of the vehicle 1 without harming the occupants of the vehicle in the interior thereof.

The foregoing disclosure has been set forth merely to illustrate the invention and is not intended to be limiting. Since modifications of the disclosed embodiments incorporating the spirit and substance of the invention may occur to persons skilled in the art, the invention should be construed to include everything within the scope of the appended claims and equivalents thereof.

1-10. (canceled)

11. A vehicle, comprising:
a battery having at least one ventilation opening; and
a vehicle support structure having multiple hollow supports,
wherein the at least one ventilation opening in the battery is connected to an interior of at least one of the multiple hollow supports, and
wherein the at least one of the multiple hollow supports is connected either directly to surroundings of the vehicle or is connected to the surroundings of the vehicle via other supports of the multiple hollow supports.

12. The vehicle according to claim 11, wherein the battery is arranged in an area of the vehicle support structure.

13. The vehicle according to claim 11, wherein the battery has a battery housing having the at least one ventilation opening, wherein the at least one ventilation opening is directly coupled to at least one opening in at least one of the multiple hollow supports.

14. The vehicle according to claim 11, wherein the at least one ventilation opening has a closure element that is a valve device, a check element, or a bursting element.

15. The vehicle according to claim 11, wherein the battery comprises a plurality of individual battery cells, each of which has a closure element that is a pressure relief valve or a bursting element.

16. The vehicle according to claim 11, wherein the at least one of the multiple hollow supports is connected to the surroundings of the vehicle via a closure element.

17. The vehicle according to claim 14, wherein the at least one closure element is configured to open as a function of pressure.

18. The vehicle according to claim 11, wherein the battery has a battery housing, wherein the battery housing or a portion of the battery housing is a component of the support structure.

19. The vehicle according to claim 18, wherein the portion of the battery housing is a floor pan of the battery housing.

20. The vehicle according to claim 18, wherein the battery housing has at least one bracing element that is a cooling device for the battery.

21. The vehicle according to claim 11, wherein the battery is configured as a traction battery for storing electrical drive power and the vehicle is at least partially electrically driven.
